(19) United States
(12) Patent Application Publication
(10) Pub. No.: US 2025/0382391 A1
(43) Pub. Date: Dec. 18, 2025

(54) METHOD OF MAKING THIOL-FUNCTIONALIZED CELLULOSE NANOCRYSTALS FOR APPLICATIONS IN RUBBER

(71) Applicant: COMPAGNIE GENERALE DES ETABLISSEMENTS MICHELIN, Clermont-Ferrand (FR)

(72) Inventors: Wadood Yasser HAMAD, Vancouver (CA); Jeremy John MEHLEM, Greenville, SC (US); Chuanwei MIAO, Richmond (CA); Lacey REID, Vancouver (CA)

(21) Appl. No.: 18/878,311

(22) PCT Filed: Jun. 30, 2023
(86) PCT No.: PCT/US2023/069548

§ 371 Date: Dec. 23, 2024

Related U.S. Application Data
(60) Provisional application No. 63/357,144, filed on Jun. 30, 2022.

(51) Int. Cl. C08B 3/14; C08B 5/00; C08J 3/14; C08J 7/14; C08L 9/06

(52) U.S. Cl. CPC C08B 3/14; C08B 5/00; C08J 3/14; C08J 7/14; C08L 9/06; C08J 2401/10; C08J 2401/16

(57) ABSTRACT

This invention relates to improved cellulose nanocrystal fillers for rubber compositions and more specifically with the grafting of disulfide and thioesters onto cellulose nanocrystals for improved performance as a filler in rubber compositions. At least one embodiment describes a method to graft thiols or disulfides on CNC surfaces via esterification exemplified by 3-mercapto-propionic acid (MPA), 3-(acetylthio) propionic acid (APA), or dithiodipronanoic acid (DTDPA). The reaction may be carried out on CNCs highly dispersed in a suitable solvent and improved reaction conditions to achieve a favorable degree of substitution, DS. The embodiment further discloses how surface thiol groups can then be protected, in a second step, as thioesters or asymmetric disulfides to tune the hydrophobicity of CNCs to improve compatibility with styrene-butadiene, SBR, or natural rubbers.

### FIELD OF THE INVENTION

The subject matter of the present invention relates to reinforcing fillers for rubber and in particular relates to surface grafting of disulfide and thioesters onto cellulose nanocrystals for use in rubber compositions.

### BACKGROUND OF THE INVENTION

Commercial rubber products contain a significant amount of fillers and additives to adjust the viscoelastic properties of the cured product for optimal performance and lifetime. The move towards more sustainable components of rubber products provides an opportunity for bio-sourced chemicals and materials, including cellulose nanocrystals (“CNC” or “CNCs”). CNCs can serve as high-performance reinforcing agents for styrene-butadiene rubber (“SBR”) products owing to their large specific surface area, particle geometry and active surfaces. However, CNC, having polar surfaces, have poor dispersibility and interfacial properties with the non-polar SBR matrix by selectively and controllably creating CNC-elastomer covalent bonding interactions during rubber mixing.

Functionalized CNCs have been developed as a reinforcing filler forming covalent crosslinks with UV-cured or vulcanized rubber elastomers, with varying degrees of reinforcement reported in natural rubber, NR, and SBR elastomers. Despite the successful modification of nanocellulose in these cases, all of these reports describe marginal improvement in mechanical properties essentially owing to the poor compatibility between the functionalized fillers and nonpolar SBR. It would be useful to have a functionalized CNC having superior dispersibility and compatibility in elastomer mixes resulting. It would be further useful if such functionalized CNCs are useful as a reinforcing filler in UV-cured or vulcanized rubber elastomers.

### SUMMARY OF THE INVENTION

Aspects and advantages of the invention will be set forth in part in the following description, or may be obvious from the description, or may be learned through practice of the invention.

A cellulose nanocrystal reinforcing filler is disclosed herein. Specifically, a cellulose nanocrystal reinforcing filler having a thiol esterified functionalization and the method of making the same is provided. An embodiment of the invention is disclosed herein where a stepwise approach is used in the making of the functionalized CNC. The first step targets a high-yielding esterification (e.g., methacrylic anhydride grafting) followed by thiol-ene “click” crosslinking. This invention also teaches that alkene hydrothiolation chemistry yields a grafted functionality incorporated through a mono-sulfide linkage, which leads to a thioacid reacting with an alkene to yield a thioester. Thioacetic acid and thiobenzoic acid were selected, both commercially available thioacids, to compare the reactivity toward acyl click reaction, and to compare the compatibility of the isolated click products. Further, thiol-ene click chemistry can also be used to graft branched thiols onto alkene-modified CNCs. Pentaerythritol tetrakis(3-mercaptopropionate)(PETMP), a commercially available four-arm thiol, can be used as a crosslinker for branched multi-vinyl monomers and other UV-crosslinking polymer systems. Thiol-ene click chemistry is used to crosslink one of the four branches of PETMP with the surface grafted alkene groups.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1. Synthetic pathways and representative products for CNC thio-esterification.

FIG. 2. FT-IR (ATR) spectra of DTDPA-grafted CNC and optimization reactions using EDC or DCC coupling agent in DMF at 80° C. with prolonged reaction time.

FIG. 3. FT-IR spectra of acyl thiol-ene click functionalized CNC using different reaction conditions compared to parent methacrylated CNC (MA-CNC) precursor.

FIG. 4. Synthetic pathway for thiolene-click reaction for thiobenzoic (TBA)-CNC.

FIG. 5. Schematic of isolation and washing procedures adapted for the TBA grafting reaction of CNCs.

FIG. 6. Solid-state ¹³C MAS NMR spectrum of freeze-dried TBA-CNC.

FIG. 7. TGA isotherm of freeze-dried TBA-CNC.

FIG. 8. DSC trace of freeze-dried TBA-CNC.

FIG. 9. True secant modulus (MPa) vs. percent tensile strain for SBR reinforced with TBA-CNC.

FIG. 10. The true secant moduli, TSM, for rubber sample reinforced with functionalized-CNCs compared with carbon black, CB, when examined at 100, 200, 300 and 400% strain.

The use of identical or similar reference numerals in different figures denotes identical or similar features.

### DETAILED DESCRIPTION OF THE INVENTION

The present invention presents a novel cellulose nanocrystal reinforcing filler for a rubber composition and a method for making the same. For purposes of describing the invention, reference now will be made in detail to embodiments and/or methods of the invention. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

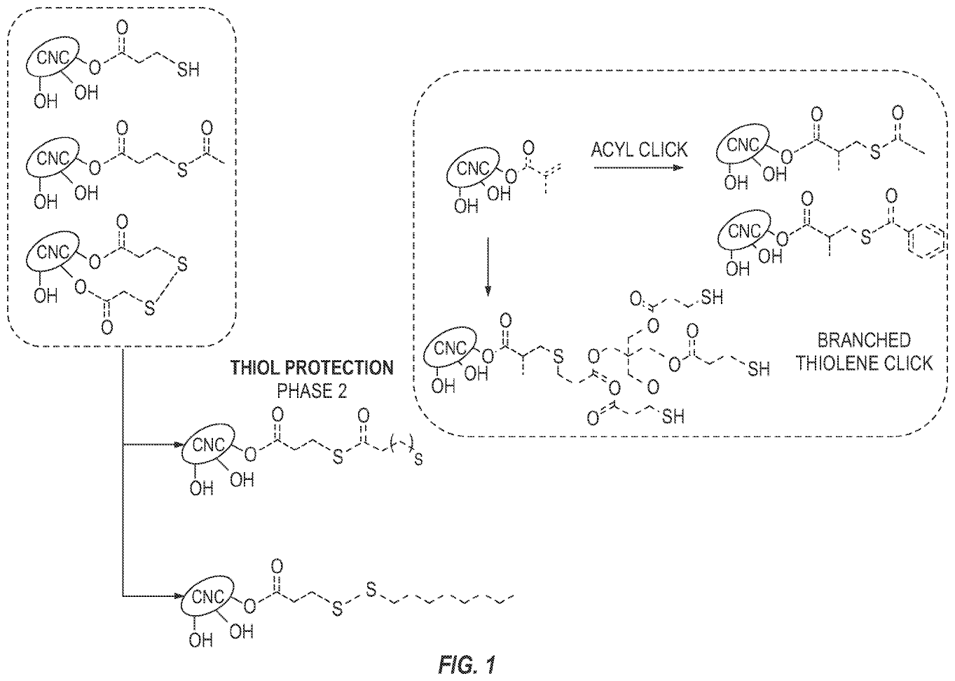

We describe below details of the results for cellulose nanocrystals, CNCs, grafted with thiol functional groups, including thiols, thioesters and disulfides, via different synthetic processes as schematically illustrated in FIG. 1.

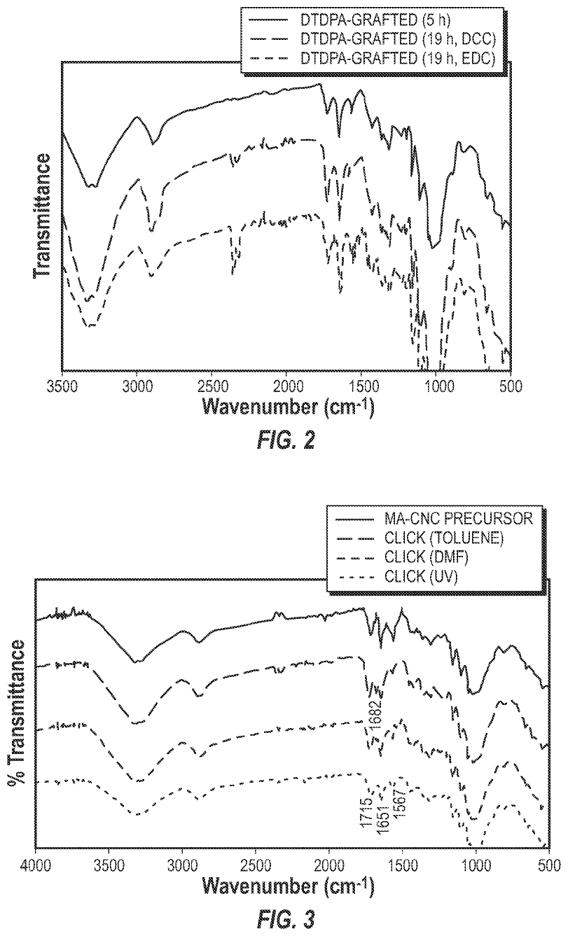

The disulfide 3,3-dithiodipropionic acid (DTDPA) was grafted onto CNC using Steglich esterification conditions, employing stoichiometric 4-dimethylaminopyridine, DMAP, catalyst and N,N′-Dicyclohexylcarbodiimide (DCC) coupling agent in dimethylfomamide, DMF (80° C.). The grafting of the DTDPA with low degree of substitution, SD, was determined to be successful from the CHNOS elemental analysis. However, the DS (the degree of substitution) was increased 3-fold by replacing the DCC coupling agent with the more reactive 1-ethyl-3-(3-dimethylaminopropyl) carbodiimide, EDC. The DS is the average number of hydroxyl groups that have been reacted on the anhydroglucose units of the cellulose. Fourier-transform infra-red, FTIR, analysis confirmed a signal corresponding to the C═O stretch of the DTDPA-CNC ester at 1733 cm⁻¹ (FIG. 2). Dispersibility tests were carried out in solvents with varying polarity, using the DTDPA-CNC product as-isolated in a paste with acetone (dispersed to 0.1 wt % in each solvent). The tests showed good dispersibility in ethyl acetate, toluene and limonene, even after standing for 2 hours undisturbed.

In characterizing the DTDPA-CNC, we can quantify the degree of mono-versus bis-grafting of the DTDPA, i.e., one or both carboxylate ends attached for each DTDPA group grafted. The DTDPA-CNC was first reduced using dithiothreitol (DTT) in methanol/phosphate buffer, pH 8, at room temperature in order to expose the free thiol groups by cleaving the disulfide. Elemental analysis of the reduced product showed a loss by half in mass percent sulfur (S %=1.17) compared to the DTDPA-CNC (S %=2.29), indicating a significant proportion of mono-grafted DTDPA present (i.e., many disulfide groups that cleaved resulted in loss of a mercaptopropionic acid group and corresponding loss in S %). The overall degree of grafting and increase the bis/mono grafting ratio was achieved by the resulting optimization of the reaction. The overall DS was improved up to DS=0.13 by increasing the reaction time from 5 to ˜20 h.

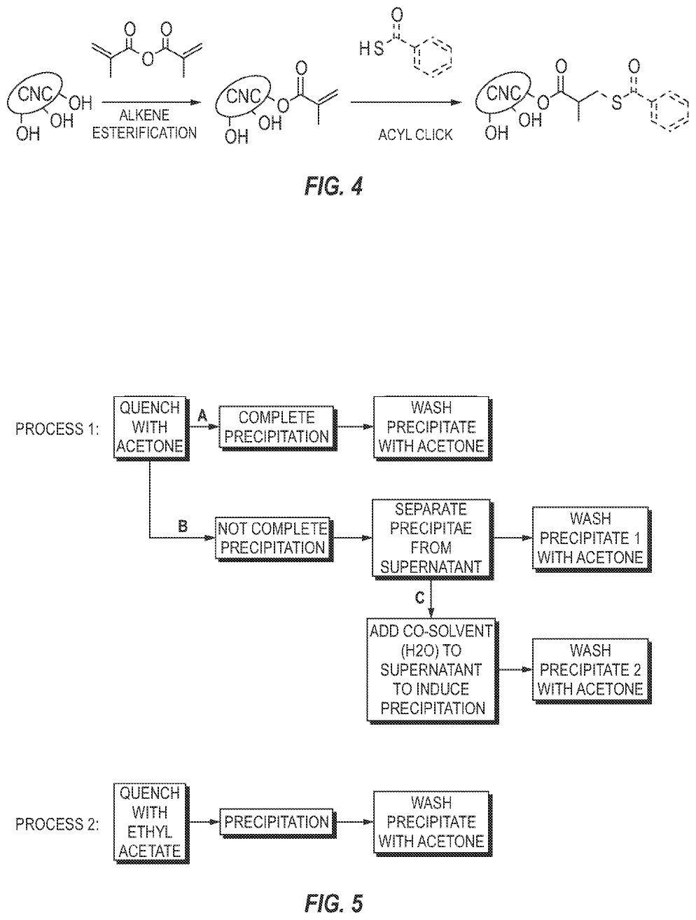

Results are provided below for CNCs grafted with a thioester, thiobenzoic acid (TBA), via thiol-ene click chemistry. Grafting can be done using two approaches. First, a stepwise approach wherein the first step targets a high-yielding esterification (e.g., methacrylic anhydride grafting) followed by thiol-ene “click” crosslinking as shown in FIG. 4. This alkene hydrothiolation chemistry yields a grafted functionality incorporated through a mono-sulfide linkage. We essentially adapt acyl thiol-ene chemistry (for small molecules) that reacts a thioacid with an alkene to yield a thioester.

Alkene-grafted CNCs, for instance, methacrylic anhydride, MA-CNC, can be used as a precursor for grafting thiols and thio-esters via thiol-ene and acyl thiol-ene click chemistry as shown in FIG. 4. Thioacetic acid can be used as the thioacid, reacted with MA-CNC with heating or at room temperature. Further, a UV-initiated reaction is possible, by adapting procedures for thiolactonization of mercaptoalkanoic acids. Reaction mixtures are typically quenched with methanol and worked up by centrifuging/washing with solvent such as, for example, methanol or acetone or combinations thereof. The reactions carried out with triethylamine base in heated solvent, which is thought to promote a “Michael addition” mechanism, are the most successful in converting alkene-to-thioester click product, with a DS of 0.15 achieved, representing approximately a 30% conversion, in toluene. FT-IR analysis of freeze-dried products from each reaction in toluene, DMF or UV-reaction, shown in FIG. 3, show a small, broadened peak shouldering the methacrylate C═O stretch, measured at 1726 cm⁻¹, that is assigned to the thioester C═O, expected at 1696 cm⁻¹.

To improve the compatibility of the products a thiobenzoic acid, TBA, was used in the click reaction to produce a more hydrophobic thioester group and hence improve dispersibility of the functionalized CNCs in SBR. The Michael-addition type reactions can be carried out at 110° C. to yield products with moderate grafting degree of the TBA groups, approaching DS of 0.2. Of the solvents screened, DMF gave the product with highest DS=0.18, which corresponds to nearly 50% conversion of the grafted alkene groups into the acyl click product, a thioester product. Click products are generally dispersible in more polar solvents, ethyl acetate, and toluene, but settle relatively quickly in limonene and heptane. It should be noted that UV-photoinitated reactions, whether in DMF solvent or neat liquid TBA at room temperature, yield lower DS, ca. 0.04-0.8, which likely results from de-activation of the photoinitiator over the duration of the reaction.

Overall optimization of the reaction conditions reveals that the TBA reaction, typically carried out in excess TBA at 80-110° C., 5 h, is not sensitive to the base catalyst employed, nor longer reaction times, and typical 0.1<DS<0.15 is obtained. Based on these results, the base catalyst can be removed thereby simplifying the procedure. Variability in S %, determined from CHNS elemental analysis, of the batches of TBA-CNC correlate with a reddish color of the product. For some reactions, using the same conditions—triethylamine base in DMF at 110° C., the color of the reaction mixture can be more variable, from amber to dark brown/reddish brown. This is thought to be the result of decomposition of the TBA and it is unknown if this may result in impurities in the TBA-CNC product.

As with the successful acyl click reactions with thioacetic and thiobenzoic acids, similar reaction conditions can be carried out for click grafting of methacrylated MA-CNC with a commercially available branched thiol, pentaerythritol tetrakis(3-mercaptopropionate) or PETMP, such as shown in FIG. 1. Toluene and DMF solvents can be screened at 110° C. with catalytic triethylamine and excess PETMP, and also a UV-photoinitated reaction in neat liquid PETMP at room temperature. Both the Michael-addition type reactions, with heating, and the UV-photoinitiated reaction in neat PETMP yield similar DS of 0.06-0.07 indicating comparable reactivity by both pathways. There are theoretically 3 exposed thiol groups per each molecule of PETMP grafted, and the “DS of exposed thiols” are estimated to be closer to 0.18-0.2. The grafting of PETMP, with 4 carboxylate groups per molecule, can be confirmed by the strong peak at 1732 cm⁻¹ from FTIR. Notably, the product of the reaction in toluene dries out quickly in air to yield a free-flowing powder which is useful for use in rubber formulation, since adding the reinforcing filler to the rubber mix as a paste in flammable solvent is undesirable. The PETMP-CNC is a highly reactive system, which when compounded with rubber can result in a highly rigid structure at low strain levels.

It is possible to notice variability in the gravimetric yield determination based on mass gain, which results from material loss during washing/purification. As such, a controlled regiment for isolation and washing procedure for the thiol-grafted reactions with CNCs was instituted as shown in FIG. 5. Using isolation process 1 of FIG. 5, the addition of excess amount of acetone to quench the reaction may lead to complete or partial precipitation of the material. When complete precipitation occurs, the precipitate is purified as usual with acetone to yield the product. However, when precipitation is incomplete after quenching with acetone, the precipitate is washed with acetone while a 1:1 volume ratio of a co-solvent, water in this case, is added to the supernatant to induce precipitation. Isolation process 2 also shown in FIG. 5, however, is carried out by quenching the reaction with ethyl acetate. In this case, a complete precipitation can be observed, and the purification is resumed with acetone.

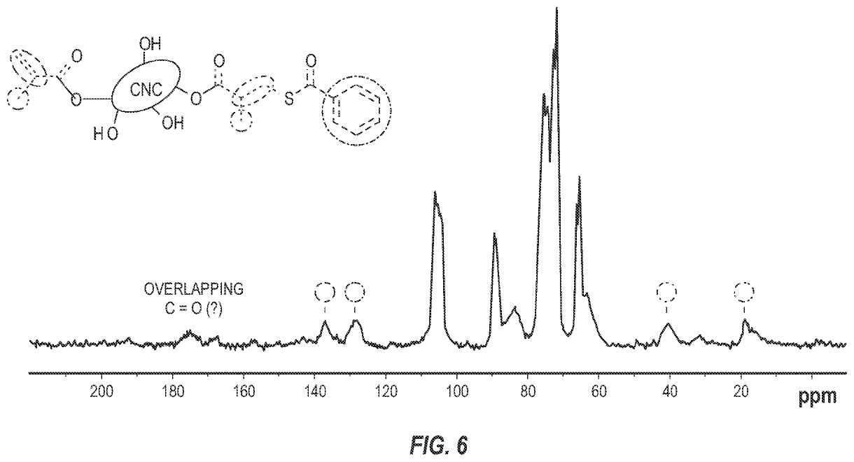

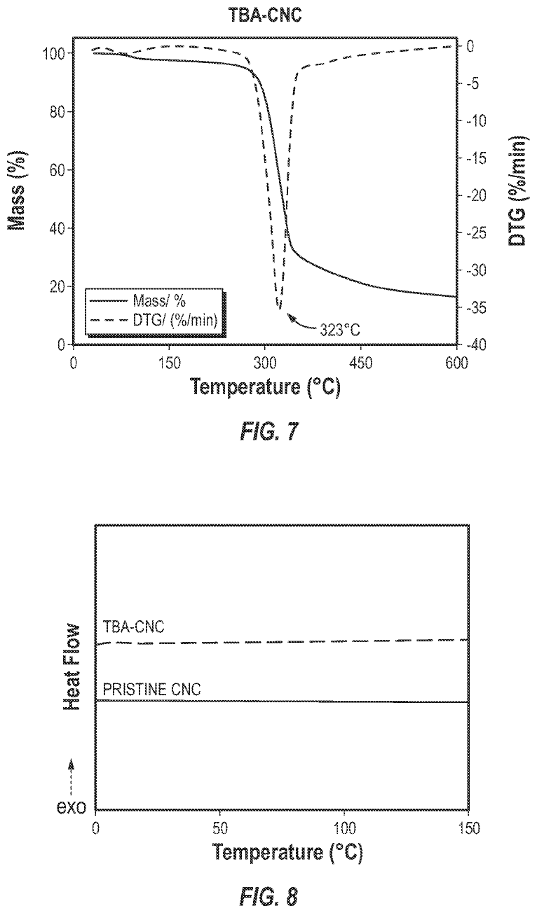

Solid state ¹³C MAS NMR of freeze-dried TBA-CNC, shown in FIG. 6, confirms a carbonyl carbon signal at 175 ppm. The two carbonyl carbons (CNC ester and thioester) may overlap within this area, or the thioester signal, expected at ˜190 ppm, may be indistinguishable from the baseline. Lack of a clear thioester peak can also indicate cleavage of the thioester during synthesis. Another small peak may be assigned to residual DMF, carbonyl ˜167 ppm. A signal at 128 ppm can be assigned to the aryl group of the thioester while a signal at 137 ppm could be assigned to the methacrylate alkene carbons from any un-grafted MA groups. The thermal properties of freeze-dried TBA-CNC were analyzed using thermogravimetric analysis, TGA, and differential scanning calorimetric, DSC, analysis and the results are shown in FIG. 7 and FIG. 8. In the TGA test, the temperature ramp rate was 20° C./min. For DSC, the temperature was ramped at a rate of 10° C./min first followed by cooling at the same rate. The TGA curves of FIG. 7 show the onset and peak decomposition temperatures at 300° C. and 323° C., respectively. At room temperature, the material contains ˜2.2% moisture. The DSC results of FIG. 8 reveal that this material does not have obvious heat capacity change in the tested temperature range.

Thiol-functionalized CNCs are therefore compatible with SBR and can directly be blended with rubber ingredients. Thiol-functionalized CNCs serve as renewable and sustainable reinforcing agents in rubber that can replace non-renewable materials like carbon black. Table 1 offers two example recipes for rubber blending. The rubber properties can be tuned by adjusting the dosage of specific ingredients in the blend, e.g., ZnO and/or crosslinking agents. Rubber mixing with thiol-functionalized CNCs can be carried out using conventional rubber processing equipment, e.g., an internal mixer, and the material can be added as a dry powder or mixed as a paste in solvent-solid contents ca. 7-40%. Conventional rubber processing equipment and procedures can be used, for example, a Haake mixer equipped with a pair of Banbury rollers. In the first step, the elastomer can be mixed with the alkene-functionalized CNCs, ZnO, stearic acid, SAD, and N-(1,3-dimethylbutyl)-N′-phenyl-p-phenylenediamine, 6PPD, at a specified temperature and speed, e.g., 90-120° C. and 70-100 rpm, respectively. Then, S and N,N-Dicyclohexyl-2-benzothiazole sulfenamide, CBS, can be mixed at a lower temperature, e.g., 50° C. and 30 rpm. The compounded rubber can be vulcanized in a steel mold at high temperature, e.g., 150° C., using a hydraulic press. If the functionalized CNCs are used as paste, then blending and solvent evaporation can take place in one of two approaches. Approach 1: Mix the paste together with the elastomer in the Haake mixer, for instance, at a temperature above the boiling point of the solvent to evaporate it. Approach 2: Dissolve the elastomer in a solvent miscible with the paste and mix them both well.

TABLE 1
Examples of rubber compounding recipes. (*equivalent
of 27 phr CNC + 8.1 phr TBA grafted, which
is iso-volume percent to the N234 carbon black.)

| | 23 wt %. Carbon | |
|---|---|---|
| | Black Example | CNC example |
| | Parts per hundred | Parts per hundred |
| Ingredients | rubber (PHR) | rubber (PHR) |
| Styrene-butadiene | 100 | 100 |
| elastomer (SBR)) | | |
| N234 Carbon Black | 32.4 | |
| Modified Cellulose | | 35.1* |
| Nanocrystals | | |
| TBA-CNC | | |
| N-(1,3-dimethylbutyl)-N′- | 2 | 2 |
| phenyl-p- | | |
| phenylenediamine (6PPD) | | |
| Zinc oxide (ZnO) | 2 | 2 |
| Stearic acid (SAD) | 1.2 | 1.2 |
| Sulfur (S) | 1.5 | 1.5 |
| N,N-Dicyclohexyl-2- | 1.5 | 1.5 |
| benzothiazole sulfenamide | | |
| (CBS) | | |

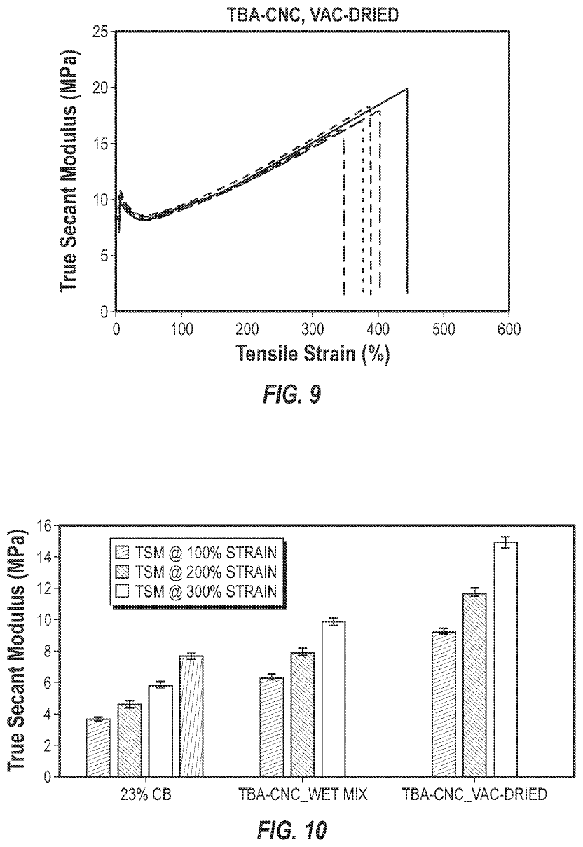

The final product can be dried using air drying, vacuum drying, freeze drying, spray drying or any other suitable technique allowing solvents to be directly removed from the system. Subsequently, this dry material can be blended with the rubber ingredients and vulcanized. It is also possible to use the solvent paste containing the functionalized CNCs and be blended directly with the rubber ingredients, while the solvent is allowed to dry. Rubber reinforced with thiol-functionalized CNCs exhibit strain behavior ca. 350-450% and a true secant modulus approaching 20 MPa at maximum strain. This material is also characterized by high true secant modulus at low strain values. For instance, at 100% the true secant modulus ˜9 MPa, and at 200% the true secant modulus is ˜11 MPa, and at 300% it is ˜15 MPa for vacuum-dried TBA-CNC. FIG. 9 and FIG. 10 depict the basis of excellent reinforcement by thiol-functionalized CNCs in rubber when compared to carbon black, a non-renewable material typically used for rubber reinforcement. FIG. 9 shows the true secant modulus curves for five vacuum dried samples (replicates). The figure clearly illustrates excellent stiffening and reinforcement at strains <150% owing the development of well connected, interpenetrated network of thiol-functionalized CNC nanoparticles. The true secant moduli (TSM), remain high as the material stretches to 300% achieving >14 MPa, which is more than twice the TSM for rubber reinforced with CB as shown in FIG. 10. This indicates the excellent dispersion and interfacial properties between thiol-functionalized CNCs and SBR and the effectiveness of the former in creating both an effective interpenetrating network for reinforcement as well as good crosslinking between the elastomer and thiol-functionalized CNC through the thiol functionalization FIG. 9 and FIG. 10 also indicates that the results, and hence reinforcing potential, is improved if the thiol-grafted CNCs are applied as a paste then dried, or vacuum dried from a solvent elastomer mixture form.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.” The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

What is claimed is:

1. The process of making a functionalized cellulose nanocrystal filler having a thiol sulfur containing ester functional group for a rubber composition comprising:
esterifying hydroxylated cellulose nanocrystals with an acid from the group consisting of 3-mercapto-propionic acid, 3-(acetylthio) propionic acid, and dithiodipronanoic acid to produce an esterified cellulose nanocrystal;
reacting the esterified cellulose nanocrystal with a thioacid by thiol-ene click chemistry
wherein the esterification occurs by methacrylic anhydride grafting.

2. (canceled)

3. The process of making a functionalized cellulose nanocrystal filler having a thiol sulfur containing ester functional group of claim 1 further comprising:
quenching the reaction with acetone.

4. The process of making a functionalized cellulose nanocrystal filler having a thiol sulfur containing ester functional group of claim 1 further comprising:
quenching the reaction with ethyl acetate.

5. The process of claim 3 further comprising:
washing the precipitate with acetone.

6. The process of claim 3 further comprising:
separating the precipitate from the supernatant;
washing the precipitate with acetone;
adding co-solvent to the supernatant to induce precipitation to produce a second precipitate; and
washing the second precipitate with acetone.

7. The process of claim 6 further comprising:
drying the final product to produce a dried functionalized cellulose nanocrystal filler.

8. The functionalized cellulose nanocrystal filler of claim 7 wherein the filler is dried by any technique belonging to the group of techniques consisting of air drying, vacuum drying, freeze drying, spray drying and combinations thereof.

9. The process of claim 1 wherein said thiol is grafted to the cellulose nanocrystal by esterification with a hydrochloric acid whereby the surfaces possess no charge.

10. The process of making a functionalized cellulose nanocrystal filler having a thiol sulfur containing ester functional group for a rubber composition comprising:
esterifying hydroxylated cellulose nanocrystals with a hydrochloric acid;
reacting the esterified cellulose nanocrystal with a thioacid by thiol-ene click chemistry.

11. The process of claim 10 further comprising:
increasing the carboxylate group density to impart a charge to the functionalized cellulose nanocrystals.

12. A rubber composition comprised of the filler produced by claim 1.

13. The process of claim 4 further comprising:
washing the precipitate with acetone.

14. The process of claim 5 further comprising:
drying the final product to produce a dried functionalized cellulose nanocrystal filler.

15. The process of claim 13 further comprising:
drying the final product to produce a dried functionalized cellulose nanocrystal filler.
